(19) United States
(12) Patent Application Publication
(10) Pub. No.: US 2013/0282576 A1
(43) Pub. Date: Oct. 24, 2013

(54) Banking Security Feature

(71) Applicant: Timothy Kinsey, Oceanside, CA (US)

(72) Inventor: Timothy Kinsey, Oceanside, CA (US)

(21) Appl. No.: 13/454,875

(22) Filed: Apr. 24, 2012

(51) Int. Cl. G06Q 40/02

(52) U.S. Cl. 705/43

(57) ABSTRACT

A bank terminal may include a security feature adapted to access a set of primary accounts if a first set of authentication data is received and a set of alternative accounts if a second set of authentication data is received, and an alert feature adapted to generate alert signals to an external entity. A method of performing secure banking procedures may determine whether an input signal matches a set of authentication and/or security criteria, and provide access to a set of primary accounts, or provide access to a set of alternative accounts, as appropriate. A system adapted to perform secure banking procedures may include an input/output module adapted to receive data from a user and provide data to the user, an authentication module adapted to determine whether authentication data matches security criteria associated with the user, and a control module adapted to control functionality of a banking terminal.

### BACKGROUND

Banking terminals (e.g., automated teller machines (ATMs), banking software applications, etc.) allow users to perform various banking functions (e.g., withdraw currency) at various different types of locations. Such a variety of types of locations may have various different security resources. At a remote banking terminal, without, for instance, security guards or human tellers, the vulnerability of a user is high. For example, many users may access ATMs at locations that are available to the general public at off hours, are poorly lit, etc. As another example, users may access financial accounts using various applications (e.g., Smartphone applications, personal computer or “PC” software, using a web browser running on a client device that is able to access a server over the Internet, etc.) in ways that may allow an outside party or entity to comprise the user's immediate and/or ongoing account security.

Current security systems are typically retroactive in nature (e.g., the output of a security camera may be reviewed after a robbery has taken place and been reported, fraudulent credit card transactions may be detected when posted to the account rather than when incurred, etc.). In addition, current security systems may alert an assailant (e.g., a mugger, a robber, etc.) that the system has been activated (e.g., through an audible alarm). Moreover, normal terminal procedures may provide an indication to the assailant that the user is attempting to subvert the assailant's efforts (e.g., if a user enters an incorrect personal identification number (PIN), the terminal may indicate that the PIN is incorrect and ask the user to try again).

For these reasons, there exists a need for transparent and proactive security to protect a user and/or limit damage when the user faces risk at a bank terminal.

### BRIEF SUMMARY

Some embodiments provide a banking security feature that may allow bank users to better control access to their accounts and/or funds in the event of a robbery or other appropriate situation. Each user may be able to configure access to a primary set of accounts using a primary PIN or password and access to one or more alternative sets of accounts using one or more alternative PINS or passwords. In addition, each user may be able to configure various security procedures associate with each set of alternative accounts or each alternative PIN or password (e.g., alerting third-parties, sounding an alarm, etc.).

In some embodiments, access to the primary and alternative accounts may be configured such that users other than a primary user are not able to discern whether the primary or alternative accounts have been accessed (i.e., it may appear to an assailant that the alternative accounts are the only accounts associated with the primary user).

Some embodiments allow the primary user to configure procedures used when the alternative accounts are accessed. For instance, various security procedures may be enabled and/or configured to operate in various different ways (e.g., limiting displayed balances, limiting withdrawal amounts, etc.) when an alternative PIN or password is used. As another example, in some embodiments an alert may be generated when an alternative PIN or password is used (e.g., an alert to on-site security, to local police, etc.). As yet another example, in some embodiments the primary user may be able to configure the security procedures such that marked currency is dispensed from a banking terminal when an alternative PIN or password is used.

Some embodiments include a bank terminal including an interface adapted to communicate with a user, a security feature adapted to access a set of primary accounts if a first set of authentication data is received through the interface and to access a set of alternative accounts if a second set of authentication data is received through the interface, and an alert feature adapted to generate alert signals to at least one external entity if a set of alert criteria is satisfied.

Some embodiments provide a method of performing secure banking procedures. The method may include receiving an input signal at a bank terminal, determining whether the input signal matches a set of authentication criteria and a set of security criteria, when determining that the input signal matches the set of authentication criteria, providing access to a set of primary accounts, and when determining that the input signal matches the set of security criteria, providing access to a set of alternative accounts.

Some embodiments provide a system adapted to perform secure banking procedures, the system comprising an input/output module adapted to receive data from a user and provide data to the user, an authentication module adapted to determine whether authentication data received from the user matches security criteria associated with the user, and a control module adapted to control functionality of a banking terminal.

The proceeding Brief Summary is intended to serve as an introduction to some embodiments of the invention. It is not meant to be an introduction or overview of all inventive subject matter disclosed in this document. The Detailed Description that follows and the drawings that are referred to in the Detailed Description will further describe the embodiments described in the Brief Summary as well as other embodiments. Accordingly, to understand all of the embodiments described in this document, a full review of the Brief Summary, Detailed Description and the drawings is needed. Moreover, the claimed subject matter is not to be limited by the illustrative details in the Brief Summary, Detailed Description and the drawings, but rather is to be defined by the appended claims, because the claimed subject matter can be embodied in the other specific forms without departing from the spirit of the invention.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a schematic diagram of a conceptual system used by some embodiments to provide secure banking;

FIG. 2 illustrates a schematic diagram of a conceptual software system with which some embodiments of the invention are implemented;

FIG. 3 illustrates a flow chart of a conceptual process that some embodiments use to configure security procedures;

FIG. 4 illustrates a flow chart of a conceptual process that some embodiments use to determine whether to perform secure banking procedures;

FIG. 5 illustrates a flow chart of a conceptual process that some embodiments use to alert local and/or third party security systems;

FIG. 6 illustrates a flow chart of a conceptual process that some embodiments use to dispense marked currency;

FIG. 7 illustrates a flow chart of a conceptual process that some embodiments use to define and store a banking security feature of some embodiments; and

FIG. 8 illustrates a schematic block diagram of a conceptual computer system with which some embodiments of the invention may be implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Although several examples above and below describe particular operations, features, etc., one of ordinary skill in the art will recognize that different embodiments may perform different operations, present different features, or otherwise differ from the examples given. For instance, although many operations are described as using an ATM, one of ordinary skill will recognize that the operations may be implemented independently of using an ATM (e.g., a user may be able to enter an alternative PIN when performing a banking transaction with a human teller in order to discreetly alert the teller to a potential security issue).

The following terms, as used herein, are defined as follows:

A “bank card” may be any element issued by a bank that allows a user to access one or more bank accounts and/or conduct banking transactions (e.g., an ATM card, debit card, etc.).

A “banking terminal” or “banking application” may include any device capable of dispensing currency or performing other bank transactions (e.g., an ATM) and/or any software and/or hardware combinations capable of allowing a user to access one or more bank accounts and/or conduct banking transactions (e.g., a Smartphone application, PC software, etc.).

A “cash cartridge” may be any container within a banking terminal that holds and allows currency to be dispensed.

A “PIN” may be any combination of characters used to authenticate a user (e.g., a set of four or more digits used to access an ATM, a password made up of various alpha-numeric characters used to activate services provided by a banking application, etc.).

A “user” may be any entity (e.g., a person, software and/or hardware, etc.) capable of controlling, accessing, and/or communicating with a banking terminal or banking application

Several more detailed embodiments of the invention are described in the sections below. Section I describes a conceptual system adapted to perform secure banking procedures. Next, Section II describes a conceptual software system with which some embodiments of the invention are implemented. Section III describes a method of operation used by some embodiments to configure the security procedures. Section IV then describes a method of operation used by some embodiments to implement secure banking procedures. Next, Section V describes a method of operation used by some embodiments to alert local and/or third-party security. Section VI then describes an example of a method of operation used by some embodiments to dispense marked currency. Next, Section VII describes the process used to define the security feature of some embodiments. Lastly, Section VIII describes a computer system which implements some of the embodiments of the invention.

### I. System Overview

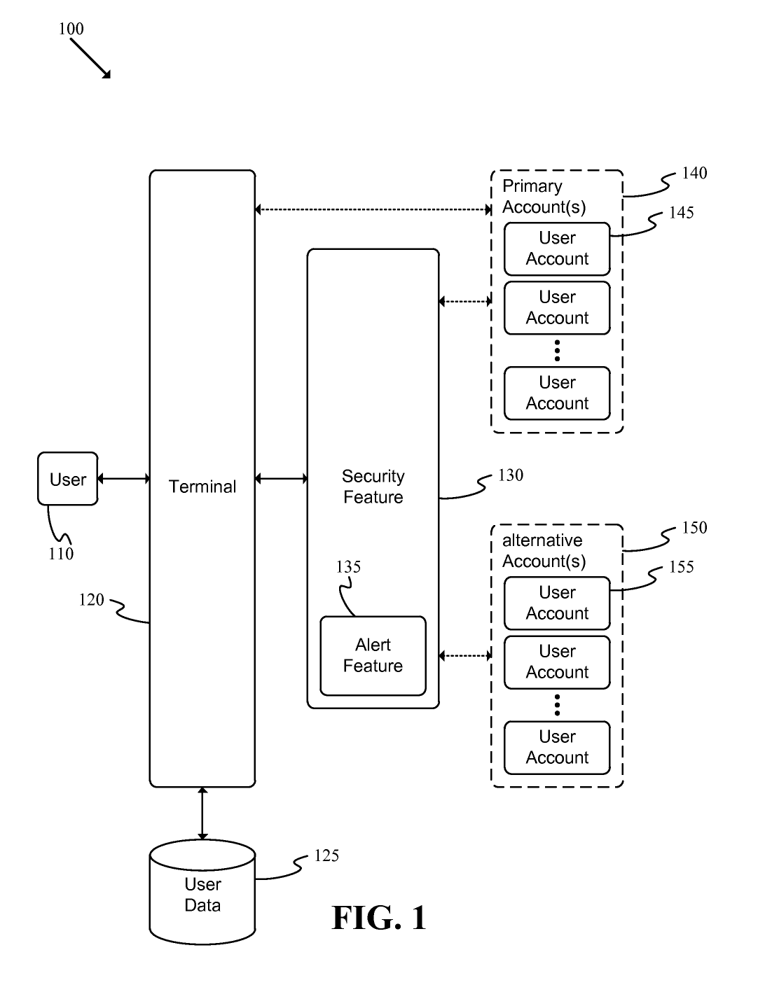

FIG. 1 illustrates a schematic diagram of a conceptual system 100 adapted to perform secure banking procedures. Specifically, this figure illustrates pathways among various components of the system (e.g. terminal, security elements, etc.). As shown, in addition to a user 110, the system 100 may include a terminal (e.g., an ATM) 120, user data 125, a security feature 130 which may include an alert feature 135, a set of primary accounts 140 (having one or more user accounts 145), and a set of alternative accounts 150 (having one or more user accounts 155).

The various components of the system 100 may be included at a single site (or single device) such as an ATM. Alternatively, the various components of the system may be spread across multiple sites and/or devices (e.g., the terminal may reside on a server which is accessed over the Internet using a Smartphone or web browser, where the security feature may be included at the Smartphone or at the server).

The user 110 may be any entity capable of controlling, accessing, and/or communicating with a banking terminal. In some embodiments, a single user may include multiple entities (e.g., a user may include a human being and a Smartphone application being manipulated by the human being).

The terminal 120 may be any banking device and/or application adapted to perform banking services (e.g. providing bank account information, dispensing currency, transferring funds, sending payments, etc.). The terminal may be adapted to access various user data 125 (e.g., the user's PIN, bank account information, etc.). In addition, the terminal 120 may be adapted to communicate with various other system elements (e.g., the security feature 130, the set 140 of primary accounts 145, etc.). The terminal may include various interfaces (e.g., wired connections, wireless connections, etc.) that may be used to communicate with various resources that may be local or remote. The terminal may include various user interface features as appropriate (e.g., keyboards, buttons, display windows, etc.).

The security feature 130 may be adapted to provide secure banking. In some embodiments, the security feature may allow a user to access either the primary accounts 140 or the alternative accounts 150. Such access may be at least partially determined using a PIN or password (e.g., when a user enters a primary PIN at an ATM the primary accounts may be accessed, while when the user enters an alternative PIN at the ATM the alternative accounts may be accessed). The security feature 130 may also be adapted to provide, when the alternative PIN is entered, a negative response to the user which may include, for example, denying access to any user accounts, indicating that the banking card is defective, indicating that the ATM is not able to dispense cash at that time, etc.

In some embodiments, the alternative PIN associated with the user may be a transposed version of the user's primary PIN (e.g., a primary PIN of “1234” may have an alternative PIN of “4321”). In some embodiments, the user may arbitrarily choose a primary and alternative PIN from among a set of available characters that may be limited in various ways (e.g., a minimum or maximum length, use of particular characters, limited to a sub-set of available characters, etc.). In some embodiments, an alternative PIN may be provided by the financial institution (e.g., “6789” may be the alternative PIN for all users).

The alert feature 135 may be adapted to alert various security entities, such as local (e.g., a security device such as a camera, on-site security or alarm system, etc.) and/or external, or third-party (e.g., police, off-site security or alarm system, etc.). The alert feature may include various communication interfaces (e.g., one or more phone lines, network interfaces, etc.) and/or components (e.g., a video or still camera, microphone, etc.) as appropriate.

The set of primary accounts 140 may include various user accounts 145 (e.g., checking, savings, credit card, brokerage, etc.). The set of alternative accounts 150 may include various user accounts 155 (e.g., checking, savings, credit card, brokerage, etc.). In some embodiments, the alternative accounts may be defined and/or limited depending on various relevant factors. For instance, a user may be able to select the type(s) of accounts that may be made available when the user accesses the alternative accounts (e.g., by entering an alternative PIN) and/or may be able to limit the withdrawal and/or charge amounts allowed by the alternative accounts. As another example, in some embodiments the alternative accounts may be defined and/or limited using default settings (e.g., the financial institution may provide a default set of alternative accounts, withdrawal limits, etc.).

During operation, the user 110 may access the terminal 120 using any available way (e.g., using an ATM, using a Smartphone application, etc.). The security feature 130 may automatically run in the background (i.e., the security feature may operate at all times to allow the terminal 110 to access the primary 140 or alternative accounts 150). Alternatively, the security feature 130 may be invoked if a user enters an alternative PIN, and/or some other appropriate way (e.g., by selecting a different language than is associated with the user, when facial recognition software does not “recognize” the user as being authorized to access the account, etc.).

In any case, when a user enters the primary PIN or password (or the security feature 130 has not been invoked), the primary accounts 140 may be accessed (e.g., normal use of an ATM card at an ATM). When the user enters the alternative PIN or password (or the security feature 130 is otherwise invoked), the alternative accounts 150 may be accessed (e.g., the alternative accounts may be presented such that someone other than the user perceives them as primary or “normal” accounts—with the ability to check balances, make withdrawals, etc.). In this way, the user may be able to prevent an assailant from accessing the user's primary account(s), such that monetary loss to the user is limited (e.g., by presenting a set of relatively limited balances rather than the user's true balances, by indicating that the terminal is malfunctioning or out of cash, etc.) while the user may be able to satisfy the assailant that the user has limited funds.

In addition, when the alternative accounts are accessed (and/or at other appropriate times), the alert feature 135 may be activated. For instance, in some embodiments when a user enters the alternative PIN, various surveillance elements may be activated (e.g., camera(s), motion sensor(s), etc.). As another example, the alert feature may send a notification to local police, appropriate security personnel, etc. As yet another example, in some embodiments an alarm may be sounded.

One of ordinary skill in the art will recognize that system 100 is conceptual and may be implemented in various different ways without departing from the spirit of the invention. For instance, in some embodiments, the user may be able to access more than two sets of accounts (e.g., a primary set of accounts may be associated with a primary PIN, a secondary set of accounts may be associated with a secondary PIN, and a tertiary set of accounts may be associated with a tertiary PIN, etc.). As another example, in some embodiments the alert feature may have various communication channels available. In addition, one of ordinary skill in the art will recognize that the various components may be implemented in various different ways (e.g., various combinations of hardware and software may be used).

### II. Software Architecture

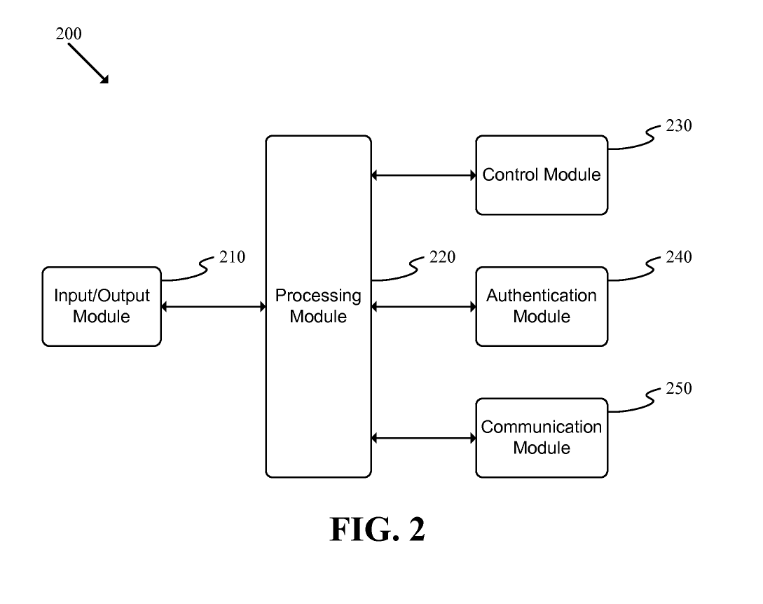

FIG. 2 illustrates a schematic diagram of a conceptual software system 200 with which some embodiments of the invention may be implemented. Specifically, this figure shows operational modules and communication pathways that may be included in the system. As shown, the system 200 may include an input/output module 210, a processing module 220, a control module 230, an authentication module 240, and a communication module 250.

The input/output module 210 may be adapted to receive data and/or instructions from a user 110. In addition, the input/output module 210 may provide information and/or instructions to a user (e.g., through a display screen, by passing data to a user application, etc.). The input/output module may receive user input in various appropriate ways (e.g., data entered using a keypad or touchscreen, data passed from a client application, etc.). The input/output module may also send information and/or instructions to and/or receive information and/or instructions from the processing module 220.

The processing module 220 may be adapted to receive data and/or instructions and/or send data and/or instructions among various other modules. In addition, the processing module may be adapted to execute various instructions, perform various operations, etc. as appropriate (e.g., the processing module may provide a PIN received from a user to the authentication module 240).

The control module 230 may be adapted to communicate with the processing module 220 and/or to interact with the banking terminal or application. For instance, the control module 230 may be adapted to cause an ATM to perform various functions, as appropriate (e.g., display balances on a screen, dispense cash, etc.). In addition, the control module 230 may be adapted to receive various data and/or instructions from the banking terminal.

The authentication module 240 may be adapted to receive and send signals to and from the processing module 220. In addition, the authentication module 240 may be able to access various appropriate user data (e.g., the user's PIN). Such data may be received from the processing module 220 and/or other appropriate components (e.g., a storage module, not shown). The authentication module 240 may also be adapted to determine whether a user is authorized to access various accounts. For instance, the authentication module may be able to determine whether a PIN entered by the user matches the PIN associated with the user's primary or alternative account(s).

The communication module 250 may be adapted to communicate among the processing module and one or more external systems (e.g., external security entities, alarm systems, etc.). As such, the communication module may include various components, interfaces, etc., as appropriate to send information and/or instructions to various external systems. The communication module may, for instance, send a signal to one or more external security systems to notify the external system(s) of a user's duress and/or request activation of secure procedures. Such notification may include appropriate information (e.g., the location of the banking terminal, the location of a user operating a Smartphone application, etc.).

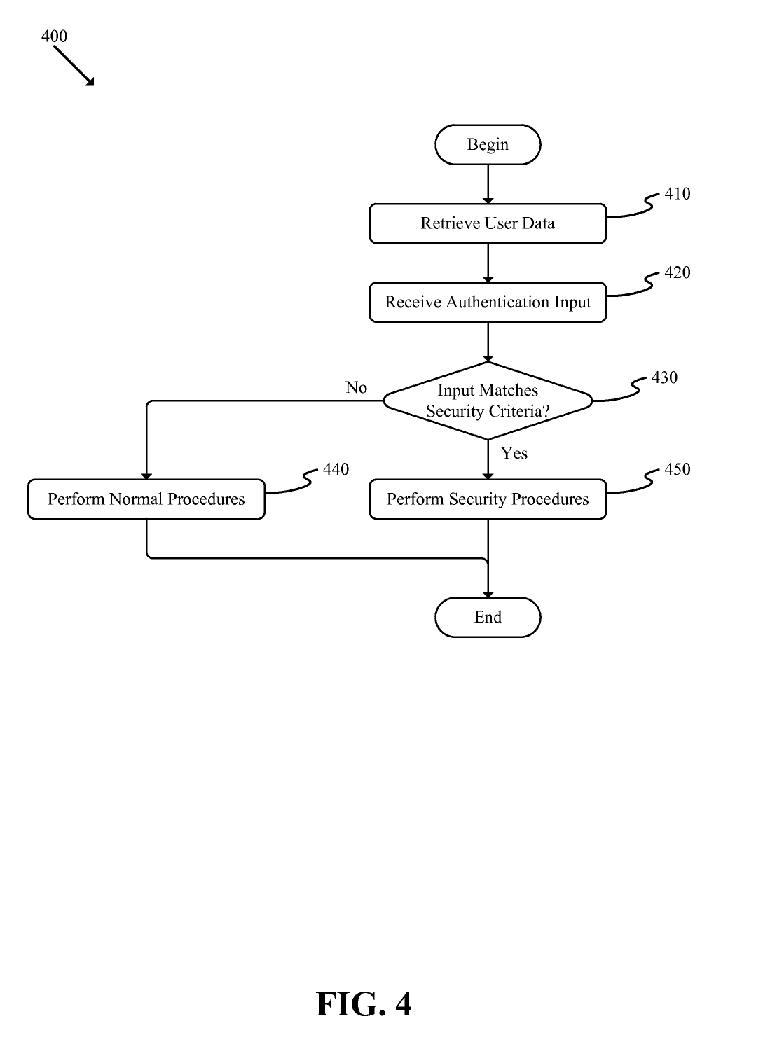

During operation, the input/output module 210 may receive a request from a user to access the user's account(s). Such request may be received by the processing module 220 and passed to the authentication module 240 for authentication. The authentication module may indicate whether primary or alternative accounts should be accessed and send the result back to the processing module 220. The processing module may then, as appropriate, send signals to the control module 230 and/or the communication module 250 in order to implement normal procedures or security procedures. The control module 230 and/or communication module 250 may, in turn, generate appropriate data and/or instructions for the terminal and/or external systems, as appropriate. The operation of system 200 will be described in more detail below in reference to FIGS. 4-6.

One of ordinary skill in the art will recognize that while the examples shown illustrate many individual modules as separate blocks (e.g., the input/output module 210, the processing module 220, etc.), some embodiments might combine these modules into a single functional block or element. One of ordinary skill in the art would also recognize that some embodiments might divide a particular module into multiple modules. In addition, one of ordinary skill in the art would recognize that the modules could be arranged in different ways, use different communication pathways, and/or communicate with other modules (not shown) without departing from the spirit of the invention. In addition, one of ordinary skill in the art will recognize that the system 200 may be embodied in other specific forms without deviating from the spirit of the invention.

### III. Configuring Security Procedures

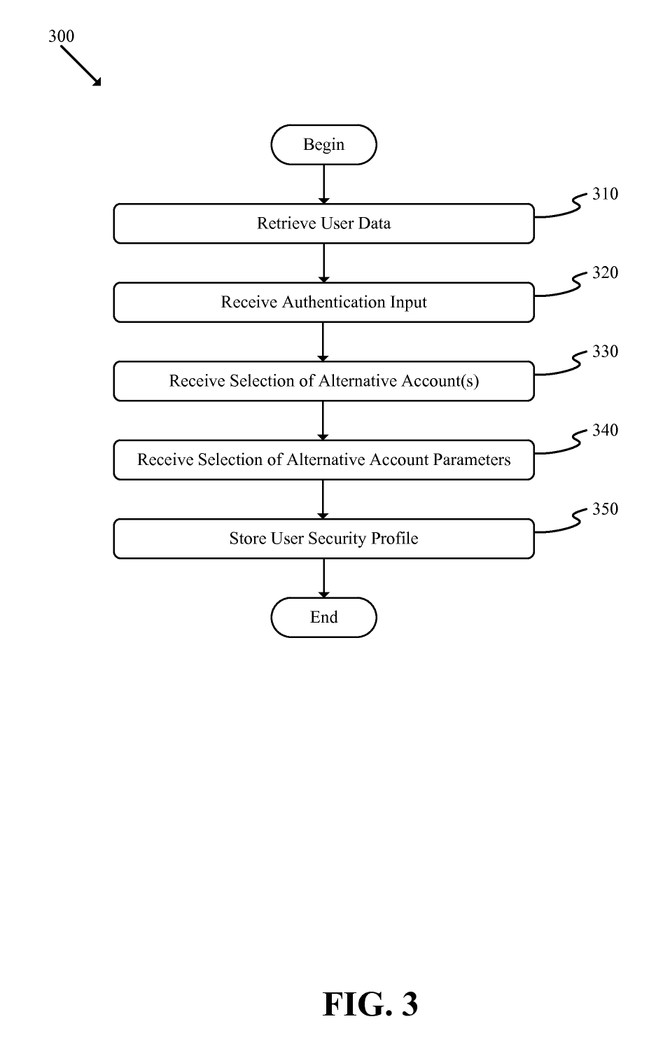

FIG. 3 illustrates a flow chart of a conceptual process 300 that some embodiments use to configure the security procedures associated with one or more users. Process 300 will be described with reference to FIGS. 1-2. Process 300 may be able to receive inputs from a bank user (e.g., an account holder), a bank employee (e.g., an information technology or security specialist), and/or other appropriate parties. The process may begin, for instance, when a user launches an application of some embodiments, when a user swipes a bank card at an ATM, etc.

As shown, the process may then retrieve (at 310) user data. Such user data may include the user's bank account information, PIN or password, etc. and may be retrieved from, for instance, user data storage 125 described above in reference to FIG. 1. Next, process 300 may receive (at 320) an authentication input (e.g., a user may enter a PIN at an ATM, enter a password on a Smartphone application, etc.). The authentication input may be received using, for instance, a terminal 120 described above in reference to FIG. 1 and a resource such as the input/output module 210 described above in reference to FIG. 2. In addition, the authentication input may be verified (not shown) versus the user's data. Such verification may be performed by a resource such as the authentication module 240 described above in reference to FIG. 2.

Process 300 may then receive (at 330) a selection of a set of alternative accounts (e.g., the set of alternative accounts 150 described above in reference to FIG. 1). The selection may be made in various appropriate ways (e.g., the user may select one or more existing accounts to be included in the alternative accounts, the user may open one or more new accounts that will serve as the alternative accounts, the accounts may be created by default according to the preferences of the bank, etc.) using various appropriate resources.

The process may then receive (at 340) a selection of alternative account parameters. Such parameters may be set in various appropriate ways (e.g., by default, based on user preferences, based on banking institute procedures, etc.). The parameters may include, for instance, one or more alternative PINs or passwords, maximum withdrawal and/or transfer amounts, under what circumstances to utilize the alert feature, etc.

As an example, in some cases, a bank user may have several primary accounts (e.g., checking, savings, brokerage, etc.) that have large balances (e.g., $10,000 or more) and/or large daily withdrawal limits (e.g., $1,000). The user may then wish to configure a set of alternative accounts that have smaller balances (e.g., up to $100) and/or small daily withdrawal and/or transfer limits (e.g., up to $100). The user may wish, for example, to configure the set of alternative accounts to be accessed when a secondary PIN or password is entered. In addition, the user may configure other parameters associated with the secondary PIN or password (e.g., do not enable the alert feature, etc.). In this way, a user may have multiple PINs or passwords that allow the user to control access to the user's bank accounts, and/or limit losses in the case of a robbery.

Continuing the above example, the primary accounts may be accessed using an ATM card and a primary PIN (i.e., the user's standard bank accounts with standard limits and security procedures). The user may then set up the set of alternative accounts to be accessed using an ATM card (which could be the same card as the user or a different card) and a secondary PIN, but without any alert being generated. Such a configuration may be useful when the user provides an ATM card to other parties (e.g., the user's children, the user's employees, etc.). Thus, the secondary PIN may enable a set of secondary users to have limited access to the primary user's funds or accounts.

To further continue the above example, the user may also set up a panic PIN that may be used by the primary user or any of the secondary users in the event of a robbery or other appropriate situation. The panic PIN may also access the alternative accounts described above (or a tertiary set of accounts), but may be configured to also initiate the alert feature to send a signal to, for example, the local police. In this way, any of the primary or secondary users may be able to initiate the special security features provided by some embodiments.

In any case, after receiving (at 340) the selection of alternative account parameters, process 300 stores (at 350) the user security profile (e.g., at user data storage 125 described above in reference to FIG. 1) and then ends. The profile may be stored in various appropriate ways (e.g., stored on a bank card's magnetic strip, stored at a server provided by the banking institution, stored on the user's access device such as a Smartphone, etc.).

One of ordinary skill in the art will recognize that the operations of process 300 are conceptual and may not necessarily be performed in the order shown. Furthermore, the process may not be performed as one continuous series of operations in some embodiments. The process may also be implemented using several sub-processes, or as part of a larger macro-process.

### IV. Performing Security Procedures

FIG. 4 illustrates a flow chart of a conceptual process 400 that some embodiments use to determine whether to perform secure banking procedures. Process 400 will be described with reference to FIGS. 1-2. Process 400 may begin, for example, when a user initiates a session at a banking terminal (e.g., by swiping a bank card at an ATM, by launching a Smartphone application, etc.). Next, the process may retrieve (at 410) user data. Such user data may include information related to the user (e.g., bank accounts the user has access to, the user's PIN, etc.) and may be retrieved locally (e.g., from the bank card) or externally (e.g., by retrieving user account information from a remote server). The user data may be retrieved (at 410), for example, from user data storage 125 described above in reference to FIG. 1, from the input/output module 210 described above in reference to FIG. 2, and/or other appropriate elements.

The process may then receive (at 420) an authentication input from the user. The authentication input may include, for example, a four-digit PIN received through an ATM keypad, a password received from a client-side application, etc. The input may be received through, for example, the terminal 120 described above in reference to FIG. 1, the input/output module 210 described above in reference to FIG. 2, and/or other appropriate elements.

Next, the process may determine (at 430) whether the received input matches any security criteria. The determination may be made by, for example, the security feature 130 described above in reference to FIG. 1 and/or the processing module 220 and/or authentication module 240 described above in reference to FIG. 2. The authentication module may compare the input received from the input/output module 210 to evaluation criteria received from the stored user data 125, for instance. The security criteria may include, for instance, a stored alternative PIN (or “panic” PIN) that when entered may initiate secure banking procedures.

When determining that the input does not match security criteria, the process may perform (at 440) normal banking procedures (e.g., access primary accounts, dispensing selected amounts of currency, etc.). When determining that the input matches the security criteria, the process may perform (at 450) security procedures (e.g., access alternative accounts, dispense limited amounts of currency, alert security, etc.). In either case, after performing (at 440 or 450) the procedures, the process ends.

One of ordinary skill in the art will recognize that the operations of process 400 are conceptual and may not necessarily be performed in the order shown. Furthermore, the process may not be performed as one continuous series of operations in some embodiments. The process may also be implemented using several sub-processes, or as part of a larger macro-process.

### V. Alert Feature

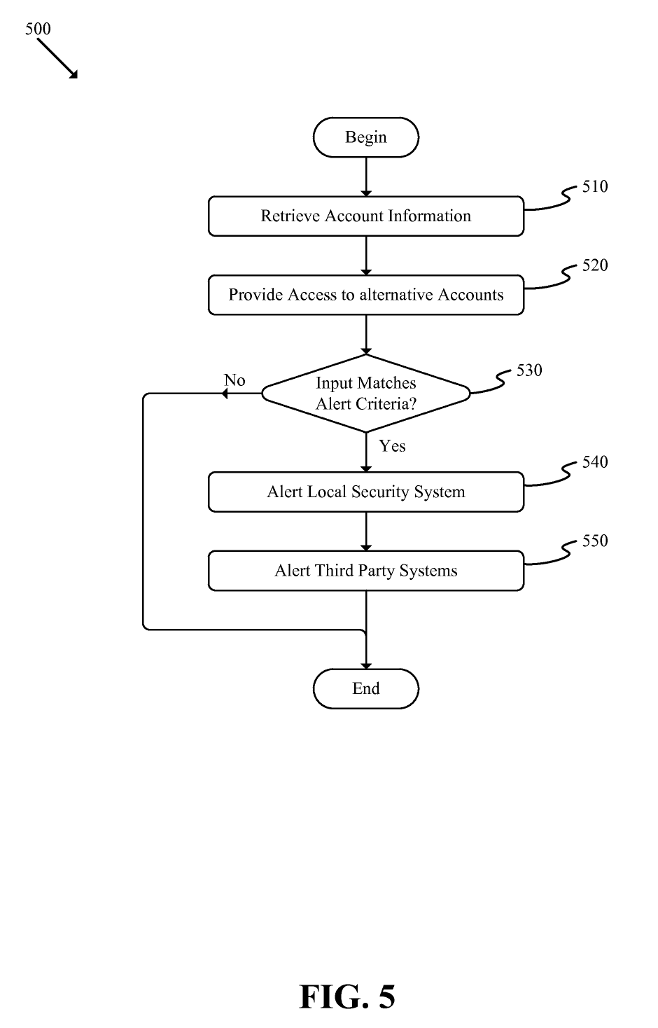

FIG. 5 conceptually illustrates a flow chart of a process 500 that some embodiments use to determine whether an alert should be sent to local and/or third-party security systems when security procedures are triggered. Process 500 will be described with reference to FIG. 4. Process 500 may begin, for example, when process 400 performs (at 450) security procedures. Process 500 may then retrieve (at 510) account information related to the user. Next, the process may provide (at 520) access to the user's alternative accounts, as described above.

The process may then determine (at 530) whether an input matches any alert criteria. The alert criteria may include various appropriate elements. For example, the alert criteria may include the alternative PIN, a “panic” button made available to the user, and/or other appropriate criteria. In some embodiments, the alternative PIN may automatically satisfy the alert criteria. In some other embodiments, a user may be required to perform additional tasks to satisfy the alert criteria. For instance, in some embodiments a user may need to input the alternative PIN and then perform another action (e.g., pressing a “panic” button provided at the banking terminal) to satisfy the alert criteria. In some embodiments, the alert criteria may include the alternative PIN and some other automatic criteria (e.g., when the alternative PIN is entered, the process may determine whether the face of a user at the physical ATM matches the account user's physical features).

In some embodiments, the process may determine (at 530) whether the input matches stored alert criteria. The stored alert criteria may include, for instance, a stored PIN number that when received from the user sends an alert from the terminal computer system to an external security network. The input may be the same input used to gain access to alternative accounts. For instance, if a user inputs a panic PIN and access to alternative accounts is allowed, that same input may automatically generate an alert. The input to alert external security systems may also be an additional input, separate from input used to access alternative accounts. The user my input an additional PIN or type in a code (e.g. on a keypad, on screen, etc.) after an alternative account is accessed that matches certain stored alert criteria (e.g., an alert may be sent only when a user attempts to withdraw money from an alternative account). There may also be separate inputs needed to alert local security systems and other third party security systems or one input may trigger alerts to both local and third party security systems.

Next, the process may alert (at 540) a local security system (e.g., a bank's system, a store's system, etc.). The process may then alert (at 550) a third party security system (e.g., police, security company, etc.). After determining (at 530) that the input does not match the alert criteria or alerting (at 540 and 550) appropriate security systems, the process ends.

One of ordinary skill in the art will recognize that the operations of process 500 are conceptual and may not necessarily be performed in the order shown. For instance, in some embodiments, once an alternative account is accessed, a button may appear on screen that a user may push to alert a local or third party security system. Furthermore, the process may not be performed as one continuous series of operations in some embodiments. Moreover, the process may be implemented using several sub-processes, or as part of a larger macro-process.

### VI. Dispensing Marked Currency

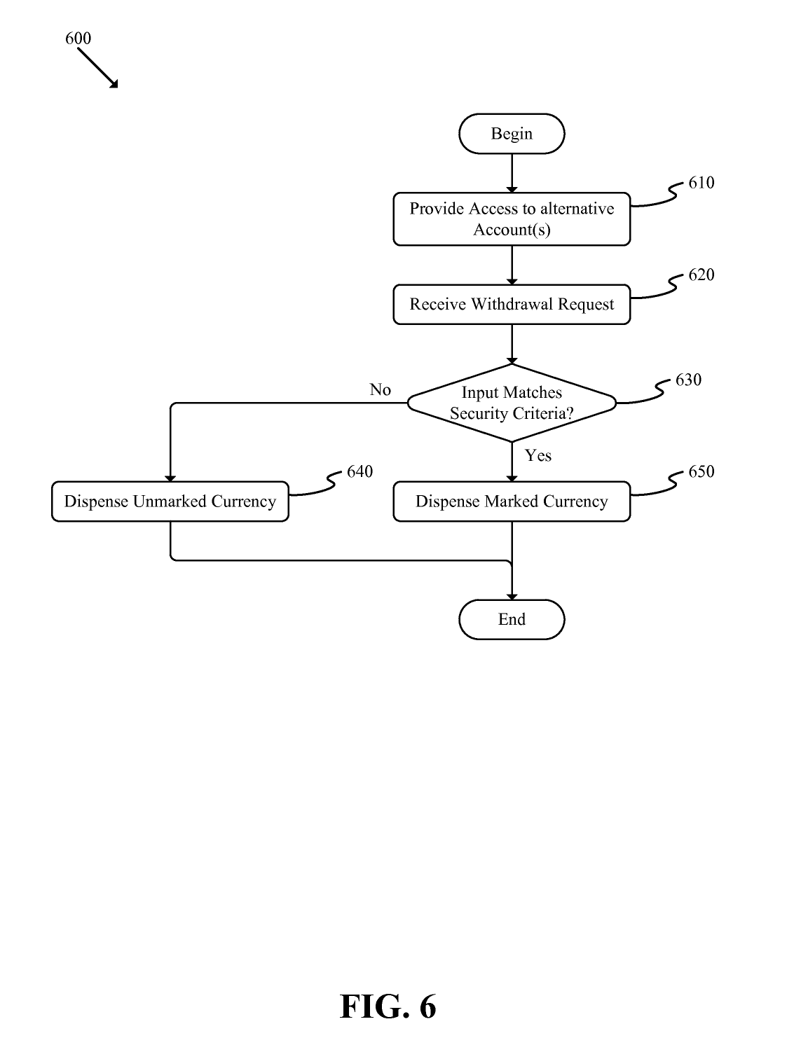

In addition to, or in place of, the security features described above (e.g., providing access to alternative accounts), some embodiments may dispense marked currency under some circumstances. FIG. 6 illustrates an example of a conceptual process 600 that some embodiments use when determining whether to dispense marked currency. Process 600 will be described with reference to FIG. 2 and process 400 described above in reference to FIG. 4.

Process 600 may begin when security procedures are implemented. For example, the process may begin when process 400 determines (at 430) that the authentication input matches security criteria and performs (at 450) security procedures. Returning to FIG. 6, process 600 may provide (at 610) access to the alternative account(s).

Next, the process may receive (at 620) a withdrawal request. Such a request may be received in various appropriate ways (e.g., a user may make a set of selections or entries using a touchscreen and/or keypad at an ATM). When an alternative account is accessed, the user may be provided an option to withdraw limited amounts of cash from that account, as described above. The withdrawal request may be received by the input/output module 210 and processed using the processing module 220.

Next, the process may determine (at 630) whether an authentication input to matches any security criteria. Such a determination may be made as described above in reference to operation 430 of process 400. The security criteria may include, for instance, the alternative PIN described above. Some embodiments may include other security criteria in addition to, or in place of, the alternative PIN. For instance, some embodiments may require that the alternative PIN be entered and another signal is received that indicates marked currency should be dispensed (e.g., a signal received from a third-party after notification is sent to the third party that the alternative PIN has been entered). In some embodiments, the security criteria may include any access to the alternative accounts (e.g., a balance request, a withdrawal request, etc.).

The determination of whether the authentication input matches the security criteria may be performed by a module such as the authentication module 240 described above in reference to FIG. 2. The authentication module 240, possible in conjunction with the processing module 220, may compare the input received from the input/output module 210 to evaluation criteria retrieved from stored user data.

When determining (at 630) that the input does not match security criteria, process 600 may dispense (at 640) unmarked currency. Alternatively, if the input matches security criteria, the process may dispense (at 650) marked currency. After dispensing (at 640 or 650) marked or unmarked currency, the process ends. The marked currency may include an ink mark on the currency or the currency may include some other identifying mark (e.g. barcode, number, magnetic strip, etc.) that enables the currency to be traced. The processing module 220 of FIG. 2 may send a signal to the control module 230 to dispense the marked or unmarked currency, as appropriate.

One of ordinary skill in the art will recognize that the operations of process 600 are conceptual and may not necessarily be performed in the order shown. Further, the process may not be performed as one continuous series of operations in some embodiments. The process may be implemented using several sub-processes, or as part of a larger macro process.

### VII. Process for Defining a Banking Security Feature

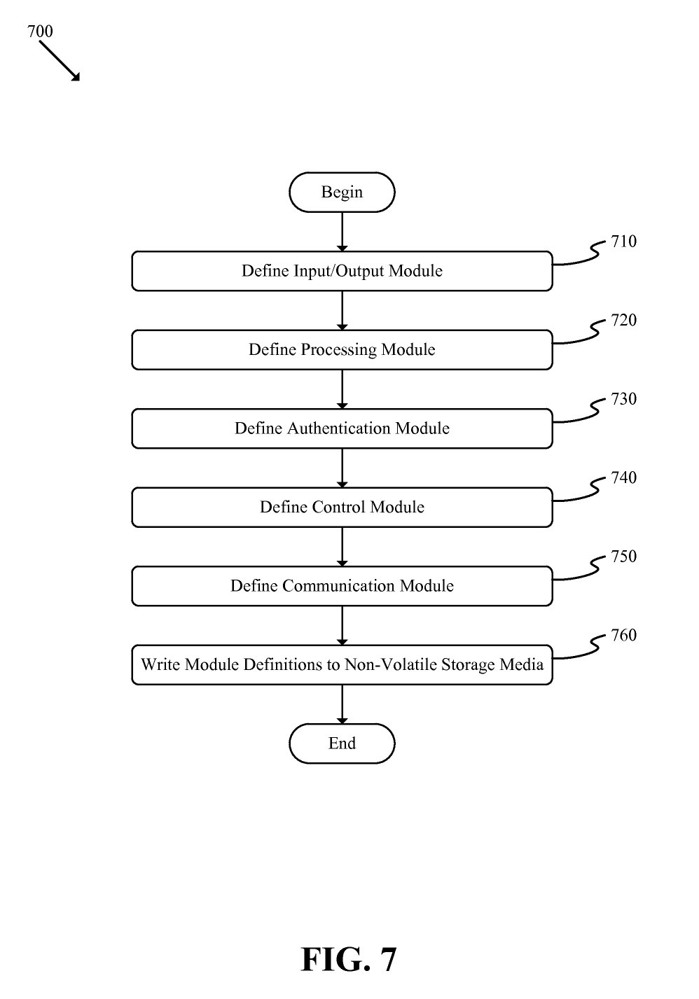

FIG. 7 illustrates a flow chart of a conceptual process 700 used by some embodiments to define and store, on a non-volatile storage medium, a banking security feature of some embodiments. For example, process 700 may be used to define and store the security feature 130 described above in reference to FIG. 1.

Process 700 may begin when a manufacturing facility generates a computer program product. As shown, the process may define (at 710) sets of instructions for implementing an input/output module (e.g., input/output module 210 described above in reference to FIG. 2). In some cases such sets of instructions are defined in terms of object-oriented programming code. For example, some embodiments may include sets of instructions for defining classes and instantiating various objects at runtime based on the defined classes.

Next, process 700 may define (at 720) sets of instructions for implementing a processing module (e.g., processing module 220 described above in reference to FIG. 2). Process 700 may then define (at 730) sets of instructions for implementing an authentication module (e.g., authentication module 230 described above in reference to FIG. 2). Next, the process may define (at 740) sets of instructions for implementing a control module (e.g., control module 240 described above in reference to FIG. 2). The process may then define (at 750) sets of instructions for implementing a communication module (e.g., communication module 250 described above in reference to FIG. 2). Next, the process may write (at 760) the defined modules to non-volatile storage media.

One of ordinary skill in the art will recognize that the various sets of instructions defined by process 700 are not exhaustive of the sets of instructions that could be defined and stored on a computer readable non-volatile storage medium for a banking security feature incorporating some embodiments of the invention. In addition, the process 700 is a conceptual process, and the actual implementations may vary. For example, different embodiments may define the various sets of instructions in a different order, may define several sets of instructions in one operation, may decompose the definition of a single set of instructions into multiple operations, etc. In addition, the process 700 may be implemented as several sub-processes or combined with other operations within a macro-process.

### VIII. Computer System

Many of the processes and modules described above may be implemented as software processes that are specified as at least one set of instructions recorded on a non-transitory storage medium. When these instructions are executed by one or more computational element(s) (e.g., microprocessors, microcontrollers, Digital Signal Processors (“DSP”), Application-Specific ICs (“ASIC”), Field Programmable Gate Arrays (“FPGA”), etc.) the instructions cause the computational element(s) to perform actions specified in the instructions.

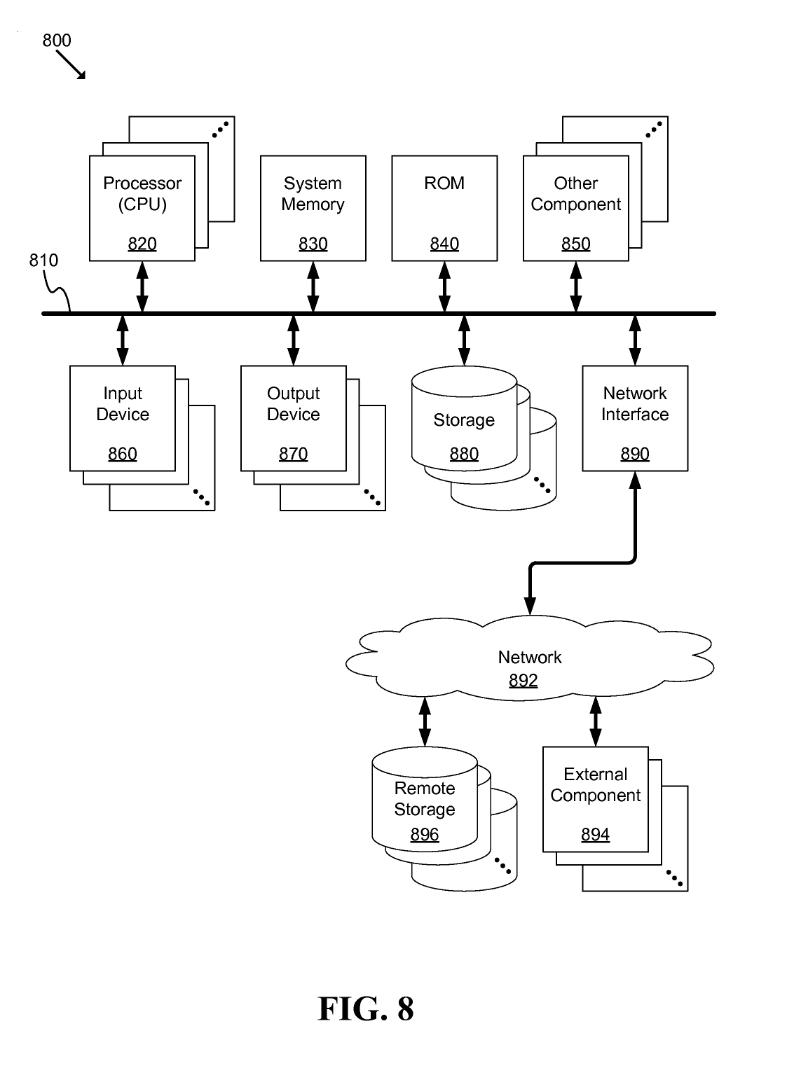

FIG. 8 conceptually illustrates a schematic block diagram of a computer system 800 with which some embodiments of the invention may be implemented. For example, the systems described above in reference to FIGS. 1-2 may be at least partially implemented using computer system 800. As another example, the processes described in reference to FIGS. 3-6 may be at least partially implemented using sets of instructions that are executed using computer system 800.

Computer system 800 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 800 may include a bus 810, at least one processing element 820, a system memory 830, a read-only memory (“ROM”) 840, other components (e.g., a graphics processing unit) 850, input devices 860, output devices 870, permanent storage devices 880, and/or a network connection 890. The components of computer system 800 may be electronic devices that automatically perform operations based on digital and/or analog input signals.

Bus 810 represents all communication pathways among the elements of computer system 800. Such pathways may include wired, wireless, optical, and/or other appropriate communication pathways. For example, input devices 860 and/or output devices 870 may be coupled to the system 800 using a wireless connection protocol or system. The processor 820 may, in order to execute the processes of some embodiments, retrieve instructions to execute and data to process from components such as system memory 830, ROM 840, and permanent storage device 880. Such instructions and data may be passed over bus 810.

ROM 840 may store static data and instructions that may be used by processor 820 and/or other elements of the computer system. Permanent storage device 880 may be a read-and-write memory device. This device may be a non-volatile memory unit that stores instructions and data even when computer system 800 is off or unpowered. Permanent storage device 880 may include a mass-storage device (such as a magnetic or optical disk and its corresponding disk drive).

Computer system 800 may use a removable storage device and/or a remote storage device as the permanent storage device. System memory 830 may be a volatile read-and-write memory, such as a random access memory (“RAM”). The system memory may store some of the instructions and data that the processor uses at runtime. The sets of instructions and/or data used to implement some embodiments may be stored in the system memory 830, the permanent storage device 880, and/or the read-only memory 840. Other components 850 may perform various other functions, as appropriate.

Input devices 870 may enable a user to communicate information to the computer system and/or manipulate various operations of the system. The input devices may include keyboards, cursor control devices, audio input devices and/or video input devices. Output devices 880 may include printers, displays, and/or audio devices. Some or all of the input and/or output devices may be wirelessly or optically connected to the computer system.

Finally, as shown in FIG. 8, computer system 800 may be coupled to a network 892 through a network adapter 890. For example, computer system 800 may be coupled to a web server on the Internet such that a web browser executing on computer system 800 may interact with the web server as a user interacts with an interface that operates in the web browser.

As used in this specification and any claims of this application, the terms “computer”, “server”, “client”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 800 may be used in conjunction with the invention. Moreover, one of ordinary skill in the art will appreciate that many other system configurations may also be used in conjunction with the invention or components of the invention.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

1. A bank terminal comprising:
an interface adapted to communicate with a user;
a security feature adapted to access a set of primary accounts if a first set of authentication data is received through the interface and to access a set of alternative accounts if a second set of authentication data is received through the interface; and
an alert feature adapted to generate alert signals to at least one external entity if a set of alert criteria is satisfied.

2. The bank terminal of claim 1, wherein the external entity is a police department communicatively coupled to the bank terminal.

3. The bank terminal of claim 1, wherein the external entity is an electronic alarm system communicative coupled to the bank terminal.

4. The bank terminal of claim 1, wherein the external entity is a video camera communicatively coupled to the bank terminal.

5. The bank terminal of claim 1, wherein the first set of authentication data includes a first personal identification number (PIN).

6. The bank terminal of claim 5, wherein the second set of authentication data includes a second PIN that is different than the first PIN.

7. The bank terminal of claim 6, wherein the alert criteria includes a third PIN that is different than the first and second PINs.

8. A method of performing secure banking procedures, the method comprising:
receiving an input signal at a bank terminal;
determining whether the input signal matches a set of authentication criteria and a set of security criteria; and
when determining that the input signal matches the set of authentication criteria, providing access to a set of primary accounts; or
when determining that the input signal matches the set of security criteria, providing access to a set of alternative accounts.

9. The method of claim 8, wherein the set of authentication criteria comprises a primary personal identification number (PIN)

10. The method of claim 9, wherein the set of security criteria comprises an alternative PIN that is different than the primary PIN.

11. The method of claim 8, wherein the set of primary accounts includes at least one of a first checking account, a first savings account, and a first brokerage account.

12. The method of claim 11, wherein the set of alternative accounts includes at least one of a second checking account, a second savings account, and a second brokerage account.

13. The method of claim 12, wherein the first checking account has a first withdrawal limit and the second checking account has a second withdrawal limit.

14. The method of claim 13, wherein the second withdrawal limit is less than the first withdrawal limit.

15. A system adapted to perform secure banking procedures, the system comprising:
an input/output module adapted to receive data from a user and provide data to the user;
an authentication module adapted to determine whether authentication data received from the user matches security criteria associated with the user; and
a control module adapted to control functionality of a banking terminal.

16. The system of claim 15, wherein the banking terminal is an automated teller machine (ATM).

17. The system of claim 16, wherein the security criteria comprises a personal identification number (PIN).

18. The system of claim 16 further comprising a communication module adapted to communicate with one or more external systems.

19. The system of claim 18, wherein the one or more external systems includes an alarm system.

20. The system of claim 15 further comprising a processing module adapted to communicate among the other modules of the system and perform various processing functions.
